(19) United States
(12) Patent Application Publication
(10) Pub. No.: US 2026/0212837 A1
(43) Pub. Date: Jul. 23, 2026

(54) DISPLAY APPARATUS AND POWER CIRCUIT THEREOF

(71) Applicant: LG Display Co., Ltd., Seoul (KR)

(72) Inventors: Hoon JANG, Paju-si (KR); Jun O HUR, Paju-si (KR)

(73) Assignee: LG Display Co., Ltd., Seoul (KR)

(21) Appl. No.: 19/392,707

(22) Filed: Nov. 18, 2025

(30) Foreign Application Priority Data
Jan. 23, 2025 (KR) 10-2025-0010480

(51) Int. Cl. G09G 3/36

(52) U.S. Cl. CPC G09G 3/3677; G09G 2310/0286; G09G 2310/0289; G09G 2310/08; G09G 2330/025; G09G 2330/027; G09G 2330/028

(57) ABSTRACT

A display apparatus includes a gate shift register to simultaneously drive pixels with a discharge scan signal of a gate high voltage to discharge residual electric charges of the pixels, in a power-off sequence, a first boosting circuit to boost the input voltage to a boost voltage in a display driving sequence, a second boosting circuit to boost the boost voltage to the gate high voltage, and a switch connected between the first and second boosting circuits. During an extra switching period of the second boosting circuit which is performed after the input voltage is down-shifted to an under voltage lock out (UVLO) level, the switch maintains an on state, and the input voltage stored in the first boosting circuit and the boost voltage stored in the second boosting circuit are applied to a power input terminal of the second boosting circuit.

### CROSS-REFERENCE TO RELATED APPLICATIONS

This application claims the benefit of and priority to Korean Patent Application No. 10-2025-0010480 filed on Jan. 23, 2025, the entire contents of which are incorporated herein by reference for all purposes as if fully set forth herein.

### BACKGROUND

### 1. Technical Field

The present disclosure relates to a display apparatus and a power circuit thereof.

### 2. Description of Related Art

Display apparatuses discharge residual electric charges of a display panel when powered off, and thus, secure a stable on/off characteristic in subsequent display driving and prevent a degradation in image quality.

A discharge scan signal of a gate high voltage should be simultaneously applied to all gate lines of a display panel for panel discharge when powered off.

A gate high voltage of a discharge scan signal is generated by a power circuit. When powered off, the supply of an input voltage is cut off, and a boost voltage stored in the power circuit is rapidly discharged, and due to this, a level of the gate high voltage generated by the power circuit is not sufficient, causing a deterioration in panel discharge characteristic.

The description of related art should not be considered prior art merely because it is mentioned in or associated with this section. The description of related art includes information that describes one or more aspects of the subject technology, and the description in this section does not limit the scope of the invention.

### SUMMARY

To overcome the aforementioned problem of the related art, the present disclosure may provide a display apparatus and a power circuit thereof, which may stably regulate a gate high voltage when powered off, and thus, may improve a panel discharge characteristic.

To achieve these aspects and other advantages and in accordance with the purpose of the disclosure, as embodied and broadly described herein, a display apparatus includes a display panel including pixels, a gate shift register configured to simultaneously drive the pixels with a discharge scan signal of a gate high voltage to discharge residual electric charges of the pixels, in a power-off sequence where supply of an input voltage is released, and a power circuit including a first boosting circuit configured to boost the input voltage to a boost voltage in a display driving sequence preceding the power-off sequence, a second boosting circuit configured to boost the boost voltage to the gate high voltage, and a switch connected between the first boosting circuit and the second boosting circuit, wherein, during an extra switching period of the second boosting circuit which is performed after the input voltage is down-shifted to an under voltage lock out (UVLO) level so as to generate the gate high voltage of the discharge scan signal in the power-off sequence, the switch maintains an on state, and the input voltage stored in a first capacitor of the first boosting circuit and the boost voltage stored in a second capacitor of the second boosting circuit are applied to a power input terminal of the second boosting circuit.

In another aspect of the present disclosure, a power circuit of a display apparatus includes a first boosting circuit configured to boost an input voltage to a boost voltage in a display driving sequence, a second boosting circuit configured to boost the boost voltage to a gate high voltage, and a switch connected between the first boosting circuit and the second boosting circuit, wherein, in a power-off sequence where supply of the input voltage is released, during an extra switching period of the second boosting circuit which is performed after the input voltage is down-shifted to an under voltage lock out (UVLO) level so as to generate a gate high voltage of a discharge scan signal used to discharge residual electric charges of all pixels included in a display panel, the switch maintains an on state, and the input voltage stored in a first capacitor of the first boosting circuit and the boost voltage stored in a second capacitor of the second boosting circuit are applied to a power input terminal of the second boosting circuit.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a diagram illustrating a display apparatus according to an embodiment of the present disclosure;

FIG. 2 is a diagram illustrating a connection configuration between a timing controller, a power circuit, and a scan driver according to an embodiment of the present disclosure;

FIG. 3 is a diagram illustrating a panel discharge operation performed in a power-off sequence;

FIG. 4 is a diagram illustrating an example where a VGH output is generated at a sufficient level, in a case where a regulation characteristic of a gate high voltage is maintained during a VGH extra switching period of a power-off sequence;

FIG. 5 is a functional block diagram of a power circuit capable of stably regulating a gate high voltage when powered off, according to an embodiment of the present disclosure;

FIG. 6 is a schematical equivalent circuit diagram of a power circuit capable of stably regulating a gate high voltage when powered off, according to an embodiment of the present disclosure;

FIG. 7 is a diagram illustrating a configuration of a second boosting circuit for a VGH extra switching operation of a power-off sequence;

FIG. 8 is a diagram illustrating an example where an input power capacity of a second boosting circuit increases for the stable regulation of a gate high voltage during a VGH extra switching period of a power-off sequence;

FIG. 9 is a diagram illustrating an operating state of a power circuit in a power-off sequence;

FIG. 10 is a diagram illustrating a comparison of an output level of a gate high voltage with respect to an input power capacity of a second boosting circuit;

FIG. 11 is a diagram illustrating an example where a boost voltage and a gate high voltage are stepwise increased by an ISO switch in a power-on sequence;

FIG. 12 is a diagram illustrating an example where a switch HS of a first boosting circuit is replaced with a Schottky diode; and

FIG. 13 is a diagram illustrating an example where a switch HS of a first boosting circuit is replaced with an NMOS transistor.

Throughout the drawings and the detailed description, unless otherwise described, the same drawing reference numerals should be understood to refer to the same elements, features, and structures.

### DETAILED DESCRIPTION

Hereinafter, example embodiments of the present disclosure will be described in detail with reference to the accompanying drawings. In the specification, in adding reference numerals for elements in each drawing, it should be noted that like reference numerals already used to denote like elements in other drawings are used for elements wherever possible. In the following description, when the detailed description of the relevant known function or configuration is determined to unnecessarily obscure the important point of the present disclosure, the detailed description will be omitted.

Like reference numerals refer to like elements. Also, a thickness, a ratio, and a dimension of each element described herein are illustrated to be partially enlarged or reduced for convenience of effective description. A scale of each element illustrated in the drawings of the present disclosure may have a scale which differs from a real scale, for convenience of description, but is not limited to a scale illustrated in the drawings.

In the present disclosure, when an arbitrary element (or a region, a layer, a portion, etc.) is described as “being on”, “connected”, or “coupled”, this may denote that the arbitrary element may be directly connected/coupled to another element, or a third element may be disposed therebetween.

The term “and/or” may include all of one or more combinations capable of being defined by relevant elements.

Terms like a first and a second may be used to describe various elements, but the elements should not be limited by the terms. These terms are merely used to refer to one element separately from another. For example, without departing from the spirit and scope of the inventive concept, a first element may be referred to as a second element, and similarly, the second element may be referred to as the first element. The terms of a singular form may include plural forms unless referred to the contrary.

The terms “under”, “below”, “on”, and “above” may be used to describe a correlation between elements illustrated in the drawings. The terms may be a relative concept and may be described with respect to a direction illustrated in the drawings. For example, unless “just” or “direct” is used, one or more other elements between two elements may be disposed. Spatially relative terms “below”, “beneath”, “lower”, “above”, and “upper” may be used herein for easily describing a relationship between one device or elements and other devices or elements as illustrated in the drawings. Therefore, for example, “under” and “lower” may be opposite to “on” and “upper” with respect to a first element.

It should be understood that spatially relative terms are terms including different orientations of elements in use or operation, in addition to the orientation illustrated in the drawings. For example, if a device in the drawings is turned over, elements described as being on the “below” or “beneath” sides of other elements may be placed on “above” sides of the other elements. Therefore, the example term “lower” may include both orientations of “lower” and “upper”. Likewise, the example term “above” or “upper” may include both orientations of above and below.

It should be understood that the meaning of “include”, “comprise”, “including”, or “comprising”, specifies a property, a region, a fixed number, a step, a process, an element and/or a component, but does not exclude other properties, regions, fixed numbers, steps, processes, elements and/or components.

Features of various embodiments of the present disclosure may be partially or overall coupled to or combined with each other and may be variously inter-operated with each other and driven technically as those skilled in the art can sufficiently understand. The embodiments of the present disclosure may be carried out independently of each other, or may be carried out together in co-dependent relationship.

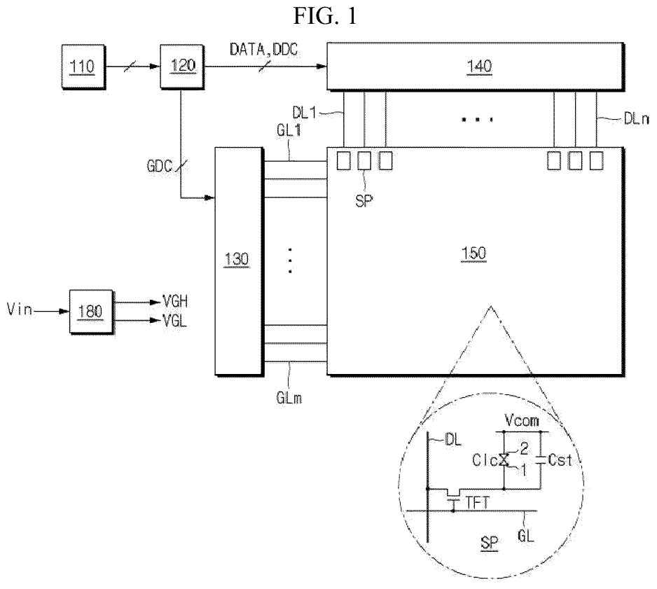

FIG. 1 is a diagram illustrating a display apparatus according to an embodiment of the present disclosure.

As illustrated in FIG. 1, the display apparatus according to an embodiment of the present disclosure may include a host system 110, a timing controller 120, a scan driver 130, a data driver 140, a display panel 150, and a power circuit 180. Based on an implementation type of the display apparatus, the timing controller 120 and the data driver 140 may be integrated into one integrated circuit (IC).

The host system 110 may output various kinds of timing signals along with image data supplied from the outside or image data stored in a memory thereof. The host system 110 may supply the image data and the timing signal to the timing controller 120.

The timing controller 120 may output a gate timing control signal GDC for controlling an operation timing of the scan driver 130 and a data timing control signal DDC for controlling an operation timing of the data driver 140, based on the timing signal. The timing controller 120 may supply the data timing control signal DDC and image data DATA to the data driver 120. The timing controller 120 may be implemented as an IC type and may be mounted on a printed circuit board (PCB), but is not limited thereto.

The scan driver 130 may output a scan signal, based on the gate timing control signal GDC supplied from the timing controller 120. The scan driver 130 may supply the scan signal to subpixels included in the display panel 150 through gate lines GL1 to GLm. The scan driver 130 may be implemented as an IC type, or may be directly formed on the display panel 150 in a gate in panel (GIP) type, but is not limited thereto.

The data driver 140 may sample and latch the image data DATA, based on the data timing control signal DDC supplied from the timing controller 120, and may map latched data to a gamma compensation voltage to generate analog data voltages. The data driver 140 may supply the data voltages to the subpixels included in the display panel 150 through data lines DL1 to DLn. The data driver 140 may be implemented as an IC type and may be mounted on the display panel 150 or a PCB, but is not limited thereto.

The power circuit 180 may generate a high-level pixel power and a low-level pixel power, based on a direct current (DC) input voltage Vin supplied from the outside. The power circuit 180 may generate a gate high voltage VGH and a gate low voltage VGL needed for driving of the scan driver 130 and a power voltage needed for driving of the data driver 140, based on the input voltage Vin.

The display panel 150 may be implemented as a liquid crystal display panel. The display panel 150 may include an upper substrate and a lower substrate which are opposite to each other with a liquid crystal cell Clc therebetween. In the display panel 150, an image corresponding to image data may be displayed on a pixel array area arranged as a matrix type. A pixel array may include a thin film transistor (TFT) array formed in a lower substrate and a color filter array formed in an upper substrate. A color filter may be formed in the TFT array of the lower substrate by using a color filter on TFT (COT) process.

In the TFT array, a TFT may be formed in each of pixel areas defined by intersections between the data lines DL1 to DLn and the gate lines GL1 to GLm. The TFT may supply a data voltage, transferred through a data line, to a pixel electrode 1 of the liquid crystal cell Clc in response to the scan signal transferred through a gate line. The liquid crystal cell Clc of each subpixel SP may be driven by a voltage difference between the pixel electrode 1 charged with a data voltage and a common electrode 2 to which a common voltage Vcom is applied, based on the TFT. The common voltage Vcom may be supplied to the common electrode 2, formed in the subpixels SP, through a common voltage supply line. A storage capacitor Cst which holds a liquid crystal cell charge voltage during one frame period may be connected to the liquid crystal cell Clc. The color filter array may include a color filter and a black matrix. A polarizer may be attached to each of an upper glass substrate and a lower glass substrate of the display panel 150, and an alignment layer for setting a pre-tilt angle of liquid crystal may be formed therein.

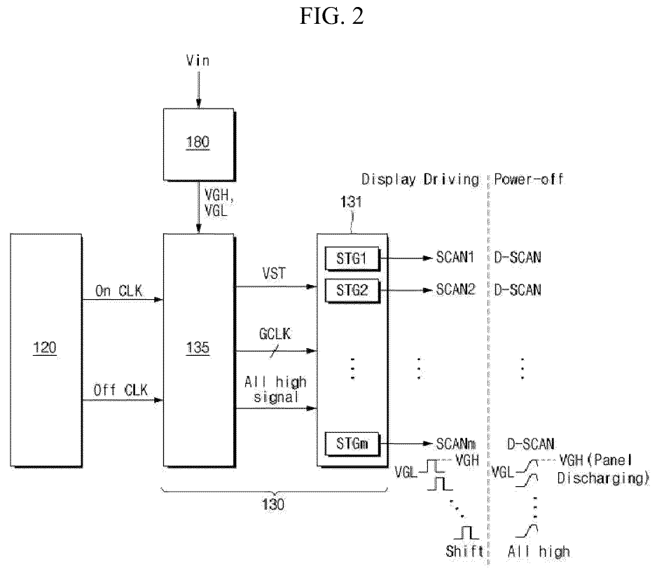

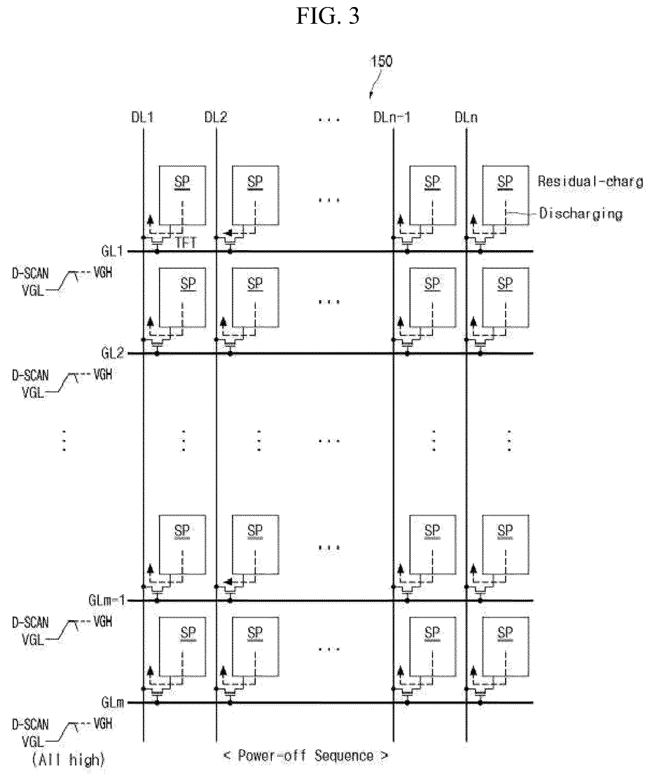

FIG. 2 is a diagram illustrating a connection configuration between a timing controller, a power circuit, and a scan driver according to an embodiment of the present disclosure. FIG. 3 is a diagram illustrating a panel discharge operation performed in a power-off sequence.

Referring to FIGS. 2 and 3, the scan driver 130 may include a level shifter 135 and a gate shift register 131.

The level shifter 135 may generate gate clocks GCLK, based on an on clock (On CLK) and an off clock (Off CLK) included in the gate timing control signal GDC input from the timing controller 120 and a gate high voltage VGH and a gate low voltage VGL input from the power circuit 180. The gate clocks GCLK may have different phases and may be supplied to the gate shift register 131 through different clock lines.

The power circuit 180 may generate the gate high voltage VGH in a power-off sequence where the supply of an input voltage Vin is released (or cut off) and may supply the gate high voltage VGH to the level shifter 135. The level shifter 135 may supply the gate shift register 131 with a gate all high signal varying between the gate low voltage VGL and the gate high voltage VGH in the power-off sequence.

A driving sequence of the display apparatus may be categorized into a power-on sequence where the supply of the input voltage Vin to the power circuit 180 starts, a power-off sequence where the supply of the input voltage Vin to the power circuit 180 is released (or cut off), and a display driving sequence arranged between the power-on sequence and the power-off sequence.

In the display driving sequence, the gate shift register 131 may receive the gate clocks GCLK from the level shifter 135 through a plurality of clock lines. The gate shift register 131 may receive a start signal VST from the level shifter 135 through a start line.

The gate shift register 131 may include a plurality of gate stages STG1 to STGm connected to each other in a dependent manner and may generate scan signals SCAN1 to SCANm, based on the gate clocks GCLK and the start signal VST. Output terminals of the gate stages STG1 to STGm may be connected to the gate lines GL1 to GLm of the display panel 150 and may supply the gate lines with the scan signals SCAN1 to SCANm where phases are sequentially shifted.

In the power-off sequence, the gate shift register 131 may generate a discharge scan signal D-SCAN of the gate high voltage VGH, based on the gate all high signal supplied from the level shifter 135, and may simultaneously supply the discharge scan signal D-SCAN to the gate lines GL1 to GLm of the display panel 150. For example, a voltage level of the discharge scan signal D-SCAN may have a voltage level of a magnitude capable of fully turning on a TFT of a subpixel SP.

In the power-off sequence, all TFTs of the display panel 150 may be simultaneously turned on by the discharge scan signal D-SCAN of the gate high voltage VGH, and thus, residual electric charges of subpixels SP may be discharged through the data lines DL1 to DLn.

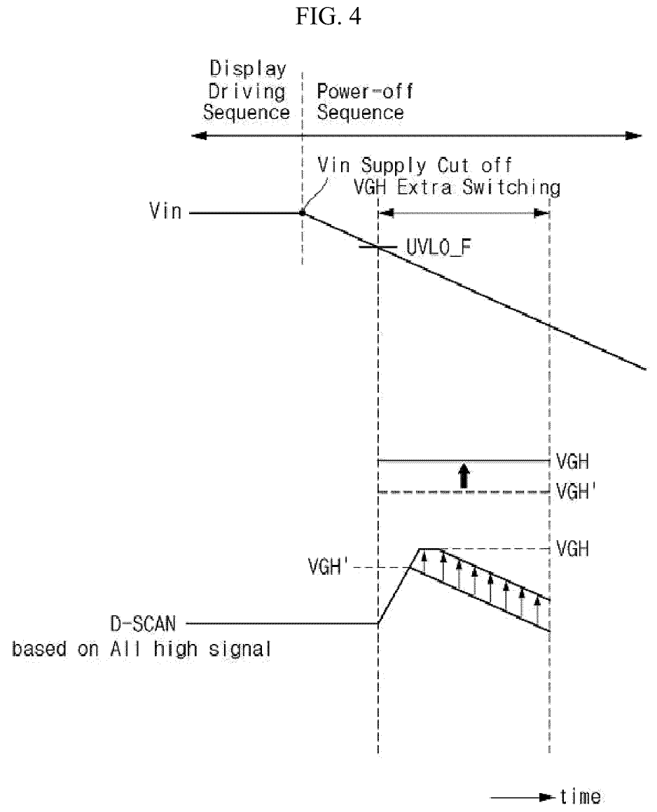

FIG. 4 is a diagram illustrating an example where a VGH output is generated at a sufficient level, in a case where a regulation characteristic of a gate high voltage is maintained during a VGH extra switching period of a power-off sequence.

Referring to FIG. 4, when the supply of an input voltage Vin to a power circuit is cut off in the power-off sequence, natural discharging of the input voltage Vin may be performed in the power circuit. Even when the input voltage Vin is down-shifted to an under voltage lock out UVLO level, i.e. UVLO_F level, the power circuit may generate a discharge scan signal D-SCAN at a gate high voltage VGH through an extra switching operation during a VGH extra switching period.

In the display driving sequence, the power circuit may boost the input voltage Vin to obtain a boost voltage and may boost the boost voltage to generate the gate high voltage VGH. The input voltage Vin and the boost voltage may be stored in capacitors of the power circuit.

When an extra switching operation for generating the gate high voltage VGH is performed in the power-off sequence, the boost voltage stored in the capacitor of the power circuit may be rapidly discharged. Based on such rapid discharging, when a VGH regulation characteristic is not maintained in the VGH extra switching period, the power circuit may output a gate high voltage VGH′ of an insufficient level. The gate high voltage VGH′ of the insufficient level may be applied to the discharge scan signal D-SCAN in the power-off sequence, a situation where the TFT of the subpixel SP is not turned on may occur, and due to this, a discharge characteristic of a panel may be degraded.

Hereinafter, the present disclosure may apply all of the input voltage Vin and the boost voltage to a power input terminal of a boosting circuit performing an extra switching operation in the power-off sequence, and thus, may reinforce a VGH boosting voltage to enhance the VGH regulation characteristic in the VGH extra switching period. Accordingly, the present disclosure may apply a gate high voltage VGH of a sufficiently high level to the discharge scan signal D-SCAN to enhance a discharge characteristic of a panel in the power-off sequence.

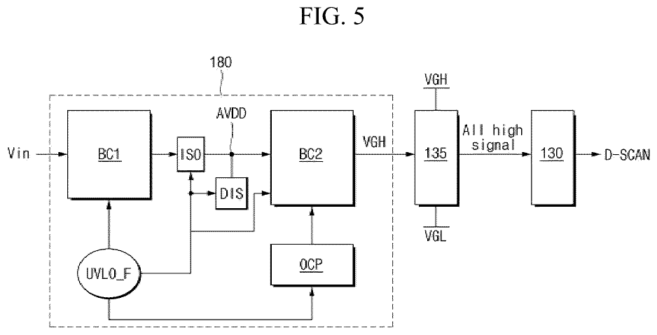

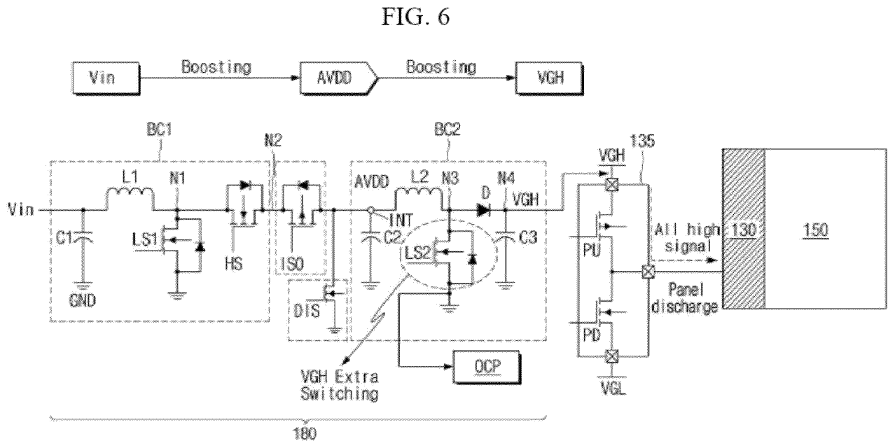

FIG. 5 is a functional block diagram of a power circuit capable of stably regulating a gate high voltage when powered off, according to an embodiment of the present disclosure. FIG. 6 is a schematical equivalent circuit diagram of a power circuit capable of stably regulating a gate high voltage when powered off, according to an embodiment of the present disclosure.

Referring to FIGS. 5 and 6, a power circuit 180 may include a first boosting circuit BC1, a second boosting circuit BC2, and an ISO switch connected between the first boosting circuit BC1 and the second boosting circuit BC2. The power circuit 180 may further include a boost voltage discharge switch DIS which is connected to a power input terminal INT of the second boosting circuit BC2. The power circuit 180 may further include an overcurrent protection circuit OCP.

The first boosting circuit BC1 may include a first capacitor C1, an inductor L1, a switch LS1, and a switch HS.

The first capacitor C1 may be connected between a terminal of an input voltage Vin and a ground voltage source GND. The inductor L1 may be connected to the terminal of the input voltage Vin and a node N1. A first electrode (one of a source and a drain) of the switch LS1 may be connected to the node N1, and a second electrode (the other of the source and the drain) of the switch LS1 may be connected to the ground voltage source GND. A first electrode of the switch HS may be connected to the node N1, and a second electrode of the switch HS may be connected to a node N2. Each of the switch LS1 and the switch HS may be implemented as a PMOS transistor.

The second boosting circuit BC2 may include a second capacitor C2, an inductor L2, a switch LS2, a diode D, and a third capacitor C3.

The second capacitor C2 may be connected between a power input terminal INT of the second boosting circuit BC2 and the ground voltage source GND. The inductor L2 may be connected to the power input terminal INT and a node N3. A first electrode of the switch LS2 may be connected to the node N3, and a second electrode of the switch LS2 may be connected to the ground voltage source GND. An anode electrode of the diode D may be connected to the node N3, and a cathode electrode of the diode D may be connected to a node N4. The switch LS2 may be implemented as a PMOS transistor. The third capacitor C3 may be connected between the node N4 and the ground voltage source GND. The node N4 which is an output terminal of the second boosting circuit BC2 may be connected to a gate high voltage VGH input terminal of a level shifter 135.

A first electrode of the ISO switch may be connected to the node N2, and a second electrode of the ISO switch may be connected to the power input terminal INT of the second boosting circuit BC2. The ISO switch may be implemented as an NMOS transistor. The ISO switch may be a switch which is needed for the stepwise sequence control of power voltages VCC, AVDD, and VGH needed for panel driving in the power-on sequence. Particularly, the ISO switch may maintain an on state in the power-off sequence to enable an OR-ing input of the input voltage Vin and a boost voltage AVDD, and thus, may reinforce an input power needed for a VGH extra switching operation of the second boosting circuit BC2. This will be described below in detail. A first electrode of the boost voltage discharge switch DIS may be connected to the power input terminal INT of the second boosting circuit BC2, and a second electrode of the boost voltage discharge switch DIS may be connected to the ground voltage source GND. The boost voltage discharge switch DIS may be turned off when performing the VGH extra switching operation of the second boosting circuit BC2, and thus, may slow down a discharge speed of the boost voltage AVDD in the power-off sequence. The overcurrent protection circuit OCP may be connected to the second electrode of the switch LS2. The overcurrent protection circuit OCP may detect whether a current flowing in the second boosting circuit BC2 is greater than a predetermined current max limit.

In the display driving sequence, the first boosting circuit BC1 may boost the input voltage Vin of the first capacitor C1 to the boost voltage AVDD to store the boost voltage AVDD in the second capacitor C2 of the second boosting circuit BC2. For example, the input voltage Vin may be 5 V, and the boost voltage AVDD may be 12 V.

For a boosting operation, the switch LS1 and the switch HS may be alternately turned on or off to be opposite to each other. When the switch LS1 is turned on, a current path passing through a terminal of the input voltage Vin, the inductor L1, and the switch LS1 may be formed, and thus, a current may be accumulated in the inductor L1. At this time, the switch HS may be turned off. On the other hand, when the switch LS1 is turned off, the switch HS may be turned on, and a current accumulated in the inductor L1 may pass through the switch HS and the ISO switch to be stored in the second capacitor C2 of the second boosting circuit BC2. Such an on/off operation may be repeated, and thus, the boost voltage AVDD which is a boosting result of the input voltage Vin may be stored in the second capacitor C2.

In the display driving sequence, the second boosting circuit BC2 may boost the boost voltage AVDD of the second capacitor C2 to the gate high voltage VGH to store a boosted voltage in the third capacitor C3. For example, the boost voltage AVDD may be 12 V, and the gate high voltage VGH may be 30 V.

For a boosting operation, the switch LS2 may be repeatedly turned on or off. When the switch LS2 is turned on, a current path passing through the power input terminal INT, the inductor L2, and the switch LS2 may be formed, and thus, a current may be accumulated in the inductor L2. At this time, the diode D may be turned off. On the other hand, when the switch LS2 is turned off, the diode D may be turned on, and a current accumulated in the inductor L2 may be stored in the third capacitor C3 via the diode D. Such an on/off operation may be repeated, and thus, the gate high voltage VGH which is a boosting result of the boost voltage AVDD may be stored in the third capacitor C3.

The gate high voltage VGH may be supplied to a VGH input terminal of the level shifter 135. The level shifter 135 may include a pull-up transistor PU and a pull-down transistor PD, which are connected between the VGH input terminal and a VGL input terminal thereof. The pull-up transistor PU may be implemented as an NMOS transistor, and the pull-down transistor PD may be implemented as a PMOS transistor. The gate high voltage VGH may be supplied to a gate shift register 131 through a connection node between the pull-up transistor PU and the pull-down transistor PD.

Moreover, in the power-off sequence, the input voltage Vin supplied to the first boosting circuit BC1 may be cut off, and the input voltage Vin of the first capacitor C1 may be naturally discharged. When the input voltage Vin is reduced up to a UVLO_F level by natural discharging, a boosting operation of the first boosting circuit BC1 may be disabled, and the second boosting circuit BC2 may further maintain a boosting operation (i.e., a VGH extra switching operation) during a VGH extra switching period, thereby outputting a gate high voltage VGH of a discharge scan signal.

During the VGH extra switching period of the power-off sequence, the switch LS1 and the switch HS may be turned off, and the ISO switch may maintain an on state, and thus, the first capacitor C1 and one electrode of the second capacitor C2 which is the power input terminal INT of the second boosting circuit BC2 may be connected to each other through the inductor L1 and a body diode of the switch HS. Therefore, during the VGH extra switching period, when the boost voltage AVDD of the second capacitor C2 is discharged and becomes lower than the input voltage Vin, the input voltage Vin stored in the first capacitor C1 may charge the second capacitor C2. As a result, during the VGH extra switching period, when the ISO switch is maintained in an on state, all of the first capacitor C1 and the second capacitor C2 may be connected to the power input terminal INT of the second boosting circuit BC2 to configure an OR-ing circuit, and thus, an input voltage of the second boosting circuit BC2 may be reinforced. Here, the OR-ing circuit is a circuit that always selects the power input with the higher voltage and supplies it to a load when there are two or more power inputs.

During the VGH extra switching period of the power-off sequence, when the boost voltage discharge switch DIS is forcibly turned off, a discharge speed of the boost voltage AVDD stored in the second capacitor C2 may be lowered in proportion thereto, and thus, the stable regulation of the gate high voltage VGH may be implemented.

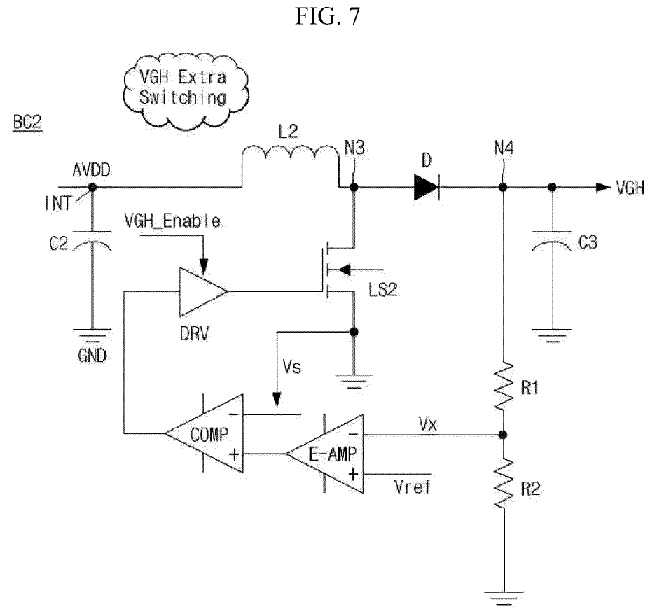

FIG. 7 is a diagram illustrating a configuration of a second boosting circuit for a VGH extra switching operation of a power-off sequence.

Referring to FIG. 7, a second boosting circuit BC2 may include a driver DRV, a comparator COMP, an error amplifier E-AMP, and a resistor string including R1 and R2, for a VGH extra switching operation.

The error amplifier E-AMP may amplify a difference voltage between a division voltage Vx of the resistor string R1 and R2 and a reference voltage Vref to output an error amplification voltage.

The comparator COMP may compare a sensing voltage, corresponding to a current flowing in a second electrode of a switch LS2, with the error amplification voltage from the error amplifier E-AMP to output a square wave signal where a duty varies.

The driver DRV may be enabled in operation, based on a VGH enable signal VGH_Enable further supplied during the VGH extra switching period. The driver DRV may increase a gate high voltage VGH in proportion to an increase in a duty of the square wave signal input from the comparator COMP.

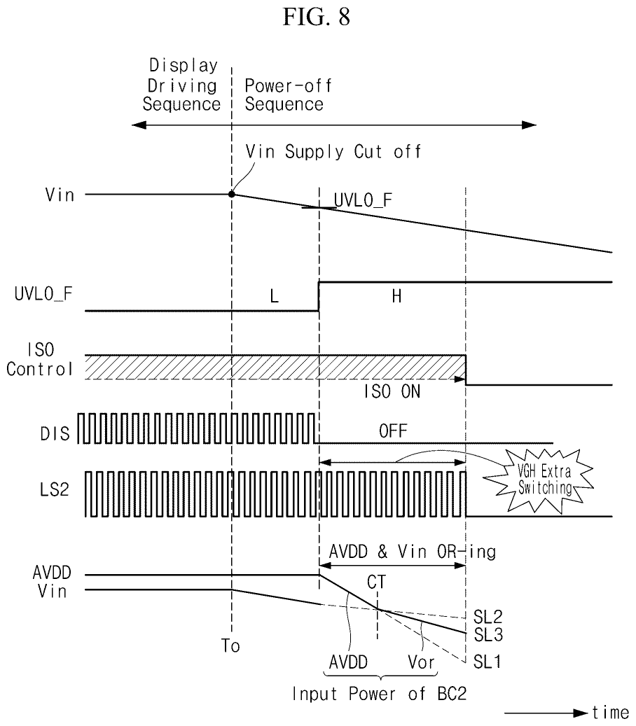

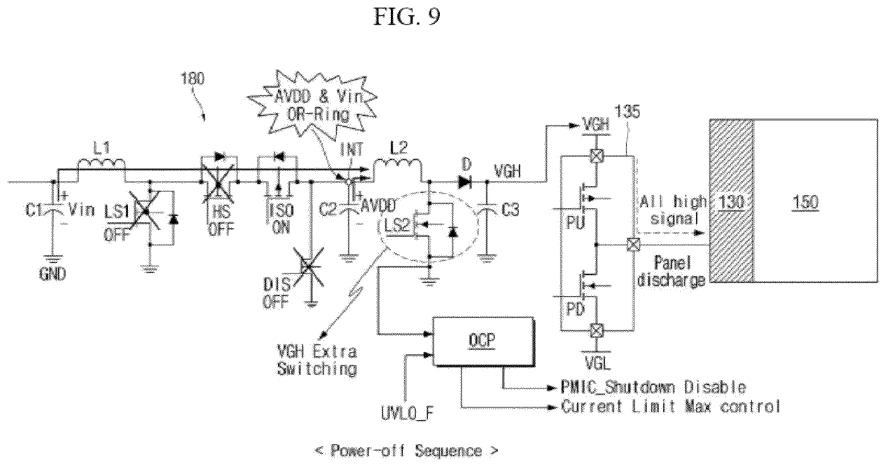

FIG. 8 is a diagram illustrating an example where an input power capacity of a second boosting circuit increases for the stable regulation of a gate high voltage during a VGH extra switching period of a power-off sequence. FIG. 9 is a diagram illustrating an operating state of a power circuit in a power-off sequence.

Referring to FIGS. 8 and 9, in the power-off sequence, the discharging of an input voltage Vin may start from a To timing at which the supply of an input voltage Vin is cut off. A certain amount of time from after the input voltage Vin is down-shifted to a UVLO_F level may be a VGH extra switching period of a second boosting circuit.

During the VGH extra switching period, a VGH extra switching operation of a switch LS2 included in the second boosting circuit may be performed. During the VGH extra switching period, an ISO switch may maintain an on state, and the input voltage Vin stored in the first capacitor C1 of the first boosting circuit and the boost voltage AVDD stored in the second capacitor C2 of the second boosting circuit may be applied to the power input terminal INT of the second boosting circuit, and thus, an OR-ing input of the boost voltage AVDD and the input voltage Vin may be implemented.

That is, during the VGH extra switching period, the boost voltage AVDD of the second capacitor C2 down-shifted with a first discharge slope SL1 and the input voltage Vin of the first capacitor C1 down-shifted with a second discharge slope SL2 which is less than the first discharge slope SL1 may be applied to the power input terminal INT of the second boosting circuit.

During the VGH extra switching period, the second boosting circuit may boost the boost voltage AVDD, which is higher than the input voltage Vin, to a gate high voltage VGH through an extra switching operation up to a cross time CT at which the first discharge slope SL1 intersects with the second discharge slope SL2.

Moreover, from after the cross time CT, an OR-ing voltage Vor which is higher than the boost voltage AVDD and lower than the input voltage Vin may be applied to the power input terminal INT of the second boosting circuit and may be boosted to the gate high voltage VGH through an extra switching operation.

The OR-ing voltage Vor may be a composite voltage of the input voltage Vin and the boost voltage AVDD at the power input terminal INT of the second boosting circuit. In the VGH extra switching period, during a period after the cross time CT, the OR-ing voltage Vor may be down-shifted with a third discharge slope SL3 which is less than the first discharge slope SL1 and greater than the second discharge slope SL2, and thus, an input power of the second boosting circuit may be reinforced.

Moreover, during the VGH extra switching period, a current max limit of the overcurrent protection circuit OCP may be set to be higher in the power-off sequence than in the display driving sequence, so that the gate high voltage VGH is more stably regulated. The overcurrent protection circuit OCP may limit a current flowing in the second boosting circuit (i.e., the switch LS2) not to exceed a predetermined current max limit. In the VGH extra switching period, because an input current increases to the degree to which the input voltage Vin is low, a shutdown function of the overcurrent protection circuit OCP for shutting down a power circuit may be previously adjusted to be disabled. The overcurrent protection circuit OCP may perform only an operation of limiting an overcurrent to less than a current max limit, and thus, a problem may be prevented where the second boosting circuit is unexpectedly shut down due to an overcurrent during the VGH extra switching period.

The current max limit of the overcurrent protection circuit OCP may be adjusted within a predetermined current range. A current max limit of the overcurrent protection circuit OCP may be set to a maximum value in the power-off sequence and may be set to a value, which is less than the maximum value, in the display driving sequence.

To secure the stability of the VGH extra switching operation, a shutdown function of the overcurrent protection circuit OCP may be enabled in only the display driving sequence and may be disabled in the power-off sequence.

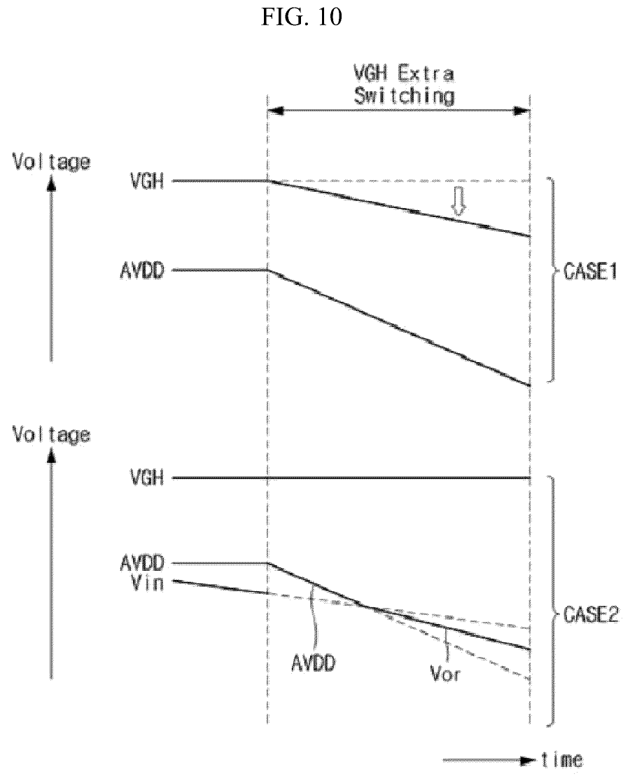

FIG. 10 is a diagram illustrating a comparison of an output level of a gate high voltage with respect to an input power capacity of a second boosting circuit.

As in CASE 1 of FIG. 10, in a case which uses only a boost voltage AVDD as an input power of a second boosting circuit, due to the rapid discharging of the boost voltage AVDD during a VGH extra switching period, the stable regulation of a gate high voltage VGH may be impossible, and a level of the gate high voltage VGH output from the second boosting circuit may be down-shifted to less than a normal level.

On the other hand, as in CASE 2 of FIG. 10, in a case which reinforces an input power of the second boosting circuit through an OR-ing input of the boost voltage AVDD and an input voltage Vin, the rapid discharging of the boost voltage AVDD during the VGH extra switching period may be prevented, the stable regulation of the gate high voltage VGH may be possible, and the level of the gate high voltage VGH output from the second boosting circuit may maintain the normal level.

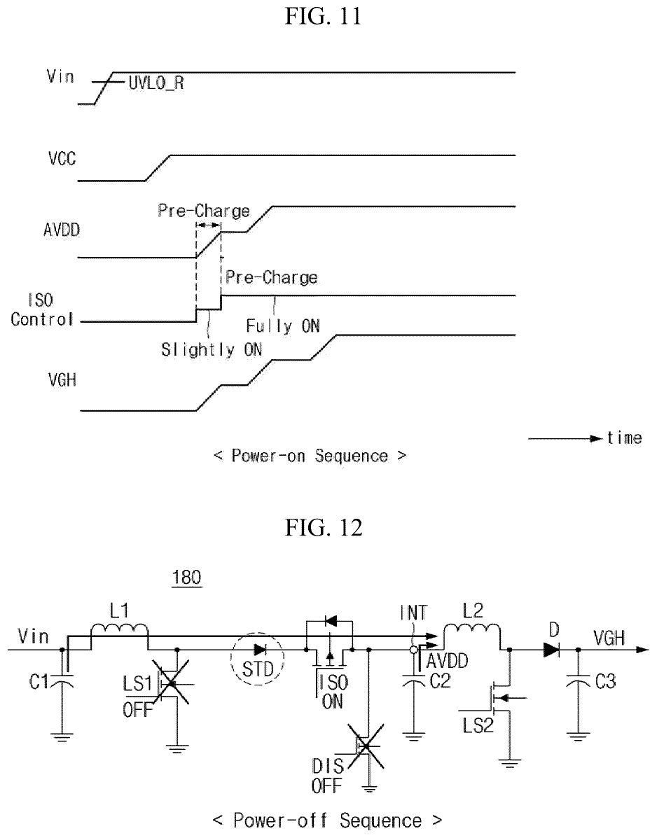

FIG. 11 is a diagram illustrating an example where a boost voltage and a gate high voltage are stepwise increased by an ISO switch in a power-on sequence.

As described above, an ISO switch of a power circuit may maintain an on state in the power-off sequence to enable an OR-ing input of a boost voltage AVDD and an input voltage Vin.

Moreover, as illustrated in FIG. 11, the ISO switch may maintain a lightly on state for certain time in the power-on sequence, and then, may be changed to a fully on state. Based on a stepwise on operation of the ISO switch, the boost voltage AVDD may be up-shifted step-by-step to a target level via a pre-charge level, and moreover, a gate high voltage VGH may be up-shifted step-by-step toward the target level.

As described above, the ISO switch may be needed for the stepwise sequence control o power voltages VCC, AVDD, and VGH in the power-on sequence.

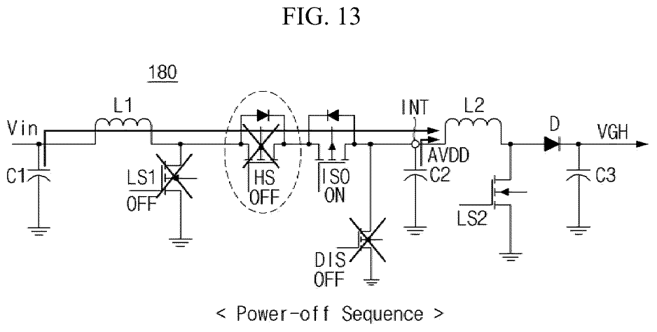

FIG. 12 is a diagram illustrating an example where a switch HS of a first boosting circuit is replaced with a Schottky diode. FIG. 13 is a diagram illustrating an example where a switch HS of a first boosting circuit is replaced with an NMOS transistor.

Comparing with FIG. 6, in a power circuit 180 of FIG. 12, a switch HS of a first boosting circuit BC1 may be replaced with a Schottky diode STD. When the switch HS of the first boosting circuit BC1 is replaced with the Schottky diode STD, the performance of an OR-ing circuit may be improved based on the Schottky diode STD which is better in current transfer capability than a body diode of the switch HS.

Comparing with FIG. 6, in a power circuit 180 of FIG. 13, a switch HS of a first boosting circuit BC1 may be replaced with an NMOS transistor. The on/off of a switch LS1 and the switch HS may be controlled by one control signal, and thus, the manufacturing cost may be favorable.

One or more aspects of the present disclosure may reinforce an input power of a second boosting circuit included in a power circuit through an OR-ing input of an input voltage and a boost voltage, in a power-off sequence. Accordingly, the present disclosure may prevent the rapid discharge of the input power during a VGH extra switching period, and thus, may enable the stable regulation of a gate high voltage, thereby improving a panel discharge characteristic.

The effects according to the present disclosure are not limited to the above examples, and other various effects may be included in the specification.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide non-limiting examples of the technical features of the present disclosure for illustrative purposes. In other words, the disclosed embodiments illustrate the scope of the technical features of the present disclosure and are not intended to be limiting in any respect. Thus, the scope of the present disclosure is not limited to the embodiments shown, but is to be accorded the widest scope consistent with the claims and their equivalents.

What is claimed is:

1. A display apparatus, comprising:
a display panel including pixels;
a gate shift register configured to simultaneously drive the pixels with a discharge scan signal of a gate high voltage to discharge residual electric charges of the pixels, in a power-off sequence where supply of an input voltage is released; and
a power circuit including a first boosting circuit configured to boost the input voltage to a boost voltage in a display driving sequence preceding the power-off sequence, a second boosting circuit configured to boost the boost voltage to the gate high voltage, and a switch connected between the first boosting circuit and the second boosting circuit,
wherein, during an extra switching period of the second boosting circuit which is performed after the input voltage is down-shifted to an under voltage lock out (UVLO) level so as to generate the gate high voltage of the discharge scan signal in the power-off sequence,
the switch maintains an on state, and
the input voltage stored in a first capacitor of the first boosting circuit and the boost voltage stored in a second capacitor of the second boosting circuit are applied to a power input terminal of the second boosting circuit.

2. The display apparatus of claim 1, wherein, during the extra switch period of the second boosting circuit, the boost voltage of the second capacitor down-shifted with a first discharge slope and the input voltage of the first capacitor down-shifted with a second discharge slope which is less than the first discharge slope are applied to the power input terminal of the second boosting circuit.

3. The display apparatus of claim 2, wherein, during the extra switching period, the second boosting circuit boosts the boost voltage, which is higher than the input voltage, to the gate high voltage through an extra switching operation up to a cross time which the first discharge slope intersects with the second discharge slope, and from after the cross time, the second boosting circuit boosts an OR-ing voltage, which is higher than the boost voltage and lower than the input voltage, to the gate high voltage through the extra switching operation.

4. The display apparatus of claim 3, wherein the OR-ing voltage is a composite voltage of the input voltage and the boost voltage at the power input terminal of the second boosting circuit.

5. The display apparatus of claim 3, wherein, during a period after the cross time of the extra switching period, the OR-ing voltage is down-shifted with a third discharge slope which is less than the first discharge slope and greater than the second discharge slope.

6. The display apparatus of claim 1, further comprising a boost voltage discharge switch connected to the power input terminal of the second boosting circuit,
wherein, during the extra switching period, a boosting operation of the first boosting circuit is disabled, and the boost voltage discharge switch is turned off.

7. The display apparatus of claim 1, further comprising an overcurrent protection circuit configured to detect whether a current flowing in the second boosting circuit is greater than a predetermined current max limit,
wherein the predetermined current max limit of the overcurrent protection circuit is higher in the power-off sequence than in the display driving sequence preceding the power-off sequence.

8. The display apparatus of claim 7, wherein, during the power-off sequence, a shutdown function of the overcurrent protection circuit for shutting down the power circuit is disabled.

9. A power circuit of a display apparatus, the power circuit comprising:
a first boosting circuit configured to boost an input voltage to a boost voltage in a display driving sequence;
a second boosting circuit configured to boost the boost voltage to a gate high voltage; and
a switch connected between the first boosting circuit and the second boosting circuit,
wherein, in a power-off sequence where supply of the input voltage is released, during an extra switching period of the second boosting circuit which is performed after the input voltage is down-shifted to an under voltage lock out (UVLO) level so as to generate a gate high voltage of a discharge scan signal used to discharge residual electric charges of all pixels included in a display panel,
the switch maintains an on state, and
the input voltage stored in a first capacitor of the first boosting circuit and the boost voltage stored in a second capacitor of the second boosting circuit are applied to a power input terminal of the second boosting circuit.

10. The power circuit of claim 9, wherein, during the extra switch period of the second boosting circuit, the boost voltage of the second capacitor down-shifted with a first discharge slope and the input voltage of the first capacitor down-shifted with a second discharge slope which is less than the first discharge slope are applied to the power input terminal of the second boosting circuit.

11. The power circuit of claim 10, wherein, during the extra switching period, the second boosting circuit boosts the boost voltage, which is higher than the input voltage, to the gate high voltage through an extra switching operation up to a cross time which the first discharge slope intersects with the second discharge slope, and from after the cross time, the second boosting circuit boosts an OR-ing voltage, which is higher than the boost voltage and lower than the input voltage, to the gate high voltage through the extra switching operation.

12. The power circuit of claim 11, wherein the OR-ing voltage is a composite voltage of the input voltage and the boost voltage at the power input terminal of the second boosting circuit.

13. The power circuit of claim 11, wherein, during a period after the cross time of the extra switching period, the OR-ing voltage is down-shifted with a third discharge slope which is less than the first discharge slope and greater than the second discharge slope.

14. The power circuit of claim 9, further comprising a boost voltage discharge switch connected to the power input terminal of the second boosting circuit,
wherein, during the extra switching period, a boosting operation of the first boosting circuit is disabled, and the boost voltage discharge switch is turned off.

15. The power circuit of claim 9, further comprising an overcurrent protection circuit configured to detect whether a current flowing in the second boosting circuit is greater than a predetermined current max limit,
wherein the predetermined current max limit of the overcurrent protection circuit is higher in the power-off sequence than in the display driving sequence preceding the power-off sequence.

16. The power circuit of claim 15, wherein, during the power-off sequence, a shutdown function of the overcurrent protection circuit for shutting down the power circuit is disabled.
